(19) United States
(12) Patent Application Publication
(10) Pub. No.: US 2023/0378695 A1
(43) Pub. Date: Nov. 23, 2023

(54) HIGH SPEED ELECTRICAL CONNECTOR WITH HIGH MANUFACTURING TOLERANCE

(71) Applicant: Amphenol Commercial Products (Chengdu) Co., Ltd., Chengdu (CN)

(72) Inventor: Jianke Zeng, Chengdu (CN)

(73) Assignee: Amphenol Commercial Products (Chengdu) Co., Ltd., Chengdu (CN)

(21) Appl. No.: 18/318,890

(22) Filed: May 17, 2023

(30) Foreign Application Priority Data
May 17, 2022 (CN) 202210538876.6
May 17, 2022 (CN) 202221193522.4

(51) Int. Cl. H01R 13/6461; H01R 13/405

(52) U.S. Cl. CPC H01R 13/6461; H01R 13/405

(57) ABSTRACT

Electrical connectors for use with high speed signals that tolerate manufacturing variations. A connector includes conductive elements disposed in first and second rows, a spacer disposed between the first and second rows of conductive elements, and a housing holding the conductive elements and the spacer. Each conductive element includes a mating end and a mounting end opposite the mating end and extending out of the housing. The spacer comprises first members contacting the conductive elements at first locations. The connector includes a second member disposed in the spacer and having projections extending beyond the spacer to contact selected conductive elements at second locations. Gaps between the spacer and the first and second rows of conductive elements may be controlled by a difference between lengths of the second member and the spacer, which provides high signal integrity despite variations in manufacturing the connector.

### RELATED APPLICATIONS

This application claims priority to and the benefit of Chinese Patent Application Serial No. 202221193522.4, filed on May 17, 2022. This application also claims priority to and the benefit of Chinese Patent Application Serial No. 202210538876.6, filed on May 17, 2022. The contents of these applications are incorporated herein by reference in their entirety.

### FIELD

This application relates to interconnection systems, such as those including electrical connectors, configured to interconnect electronic assemblies.

### BACKGROUND

Electrical connectors are used in many electronic systems. It is easier and more cost effective to manufacture a system as separate electronic assemblies, such as printed circuit boards (“PCBs”), which may be joined together with electrical connectors. A known arrangement for joining several printed circuit boards is to have one printed circuit board serve as a backplane. Other printed circuit boards, called “daughter boards” or “daughter cards,” may be connected through the backplane.

A known backplane has the form of a printed circuit board onto which many connectors may be mounted. Conductive traces in the backplane may be electrically connected to signal conductive elements in the connectors so that signals may be routed between the connectors. Daughter cards may also have connectors mounted thereon. The connectors mounted on a daughter card may be plugged into the connectors mounted on the backplane. In this way, signals may be routed among the daughter cards through the backplane. The daughter cards may plug into the backplane at a right angle. The connectors used for these applications may therefore include a right angle bend and are often called “right angle connectors.” Other known connectors include, but are not limited to, orthogonal connectors. Electrical connectors can also be used in other constructions to interconnect other types of devices, such as cables, to printed circuit boards.

Regardless of the exact application, electrical connector designs have been adapted to trends in the electronics industry. Electronic systems have gotten smaller, faster, and functionally more complex. Because of these changes, the number of circuits in a given area of an electronic system, along with the frequencies at which the circuits operate, have increased significantly in recent years. Current systems pass more data between printed circuit boards and require electrical connectors that are electrically capable of handling more data at higher speeds than connectors of even a few years ago.

In a high density, high speed connector, electrical conductors may be so close to each other that there may be electrical interference between adjacent signal conductors. To reduce interference, and to otherwise provide desirable electrical properties, shield members are often placed between or around adjacent signal conductors. The shields may prevent signals carried on one conductor from creating “crosstalk” on another conductor. The shield may also impact the impedance of each conductor, which may further affect electrical properties.

Other techniques may be used to control the performance of a connector. For example, transmitting signals differentially may reduce crosstalk. Differential signals are carried on a pair of conductive paths, called a “differential pair.” The voltage difference between the conductive paths represents the signal. In general, a differential pair is designed with preferential coupling between the conductive paths of the pair. For example, the two conductive paths of a differential pair may be arranged to run closer to each other than to adjacent signal paths in the connector. No shielding is desired between the conductive paths of the pair, but shielding may be used between differential pairs. Electrical connectors can be designed for differential signals as well as for single-ended signals.

### BRIEF SUMMARY

Aspects of the present disclosure relate to high speed electrical connectors with high manufacturing tolerance.

Some embodiments relate to an electrical connector. The electrical connector may include a housing having an interfacing surface, a mounting surface, and a slot at the interfacing surface, wherein the housing is elongated in a longitudinal direction; a plurality of conductive elements held by the housing and disposed in first and second rows parallel to the longitudinal direction, each of the plurality of conductive elements comprising a contact end having a contact portion curving into the slot, a mounting end extending out of the mounting surface, and an intermediate portion comprising a first portion and a second portion; a spacer disposed between the first and second rows, the spacer comprising a first portion disposed between the first portions of the conductive elements, a second portion disposed between the second portions of the conductive elements, and a plurality of first members extending from the first portion of the spacer and contacting the plurality of conductive elements at first locations of the plurality of conductive elements; and a second member disposed between the first and second portions of the spacer and contacting at least a portion of the plurality of conductive elements at second locations of the plurality of conductive elements.

Optionally, the electrical connector may include a first gap between the first row of the conductive elements and the first portion of the spacer. The first gap may have a width in a transverse direction perpendicular to the longitudinal direction. The width of the first gap may be uniform in a vertical direction perpendicular to both the transverse direction and the longitudinal direction.

Optionally, the electrical connector may include a second gap between the second row of the conductive elements and the first portion of the spacer. The second gap may have a width in the transverse direction. The width of the second gap may be uniform in the vertical direction.

Optionally, the electrical connector may include a third gap between the first row of the conductive elements and the second portion of the spacer. The third gap may have a width in the transverse direction. The width of the third gap may be uniform in the vertical direction.

Optionally, the electrical connector may include a fourth gap between the first row of the conductive elements and the second portion of the spacer. The interfacing surface and mounting surface may be perpendicular to each other. The fourth gap may have a width in the vertical direction. The width of the fourth gap may be uniform in the transverse direction.

Optionally, the electrical connector may include a fifth gap between the second row of the conductive elements and the second portion of the spacer. The fifth gap may have a width in the vertical direction. The width of the fifth gap may be uniform in the transverse direction.

Optionally, the spacer may be insulative; the second member may be lossy; and the at least a portion of the plurality of conductive elements may be configured for grounding.

Optionally, the electrical connector may include a third member contacting the plurality of conductive elements at third locations of the plurality of conductive elements. The third locations may be between the contact ends and the second locations of the plurality of conductive elements.

Optionally, the third member may comprise notches on opposite ends in the longitudinal direction; and the second portion of the spacer may comprise latches disposed in the notches of the third member.

Optionally, the spacer may comprise a receiving space between the first and second portions; and the second member may be removably disposed in the receiving space of the spacer.

Optionally, the receiving space may comprise a recess and a plurality of openings; the recess may be disposed at a first side of the spacer; and the plurality of openings may extend from the recess to a second side of the spacer, the second side being opposite the first side.

Optionally, the second member may comprise a body disposed in the recess of the spacer, a plurality of first projections protruding towards the second row of conductive elements, and a plurality of second projections disposed in respective ones of the plurality of openings of the spacer and protruding towards the first row of conductive elements.

Optionally, the plurality of second projections may extend longer than the plurality of first projections.

Some embodiments relate to an electrical connector. The electrical connector may include a housing having an interfacing surface, a mounting surface, and a slot at the interfacing surface and elongating in a longitudinal direction; a plurality of conductive elements held by the housing and disposed in first and second rows parallel to the longitudinal direction, each of the plurality of conductive elements comprising a contact end having a contact portion curving into the slot, a mounting end extending out of the mounting surface, and an intermediate portion comprising a first portion and a second portion; and a spacer disposed between the first and second rows, the spacer comprising a plurality of first members each at least partially wrapping a respective one of the plurality of conductive elements at first locations.

Optionally, the first locations may be at the mounting ends of the plurality of conductive elements.

Optionally, the spacer may comprise protrusions disposed on opposite ends in the longitudinal direction; and the housing may comprise matching receivers for the protrusions of the spacer so as to prevent the spacer from moving relative to the housing in the longitudinal direction.

Optionally, the spacer may comprise a receiving space; and the electrical connector may comprise a second member removably disposed in the receiving space of the spacer and contacting at least a portion of the plurality of conductive elements at second locations.

Some embodiments relate to an electrical connector. The electrical connector may include a housing having an interfacing surface, a mounting surface, and a slot at the interfacing surface and elongating in a longitudinal direction; a plurality of conductive elements held by the housing and disposed in first and second rows parallel to the longitudinal direction, each of the plurality of conductive elements comprising a contact end having a contact portion curving into the slot, a mounting end extending out of the mounting surface, and an intermediate portion comprising a first portion and a second portion; a spacer disposed between the first and second rows; and a lossy member disposed in the spacer and comprising a plurality of projections extending beyond the spacer to make contact with at least a portion of the plurality of conductive elements.

Optionally, the spacer may be separated from the first and second rows of conductive elements by first and second gaps, respectively; and sizes of the gaps may be at least partially determined by a difference between lengths of the lossy member and the spacer in a transverse direction perpendicular to the longitudinal direction.

Optionally, the spacer may comprise a plurality of insulative members each at least partially wrapping a respective one of the plurality of conductive elements at the mounting ends.

Some embodiments relate to an electrical connector. The electrical connector may comprise an insulating housing having an interfacing surface and a mounting surface, a plurality of conductive elements held by the insulating housing and a positioning assembly. The plurality of conductive elements may be arranged in a row in a longitudinal direction. Each of the plurality of conductive elements may extend from the interfacing surface to the outside of the mounting surface. The longitudinal direction may be parallel to the interfacing surface and the mounting surface. The positioning assembly may comprise first members and a second member. The first members may contact the plurality of conductive elements at first locations, and the second member may contact at least a portion of the plurality of conductive elements at second locations. The first locations and the second locations may be spaced apart in extension directions of the plurality of conductive elements.

Optionally, the electrical connector further may comprise an insulating spacer arranged in the insulating housing, and the first members and the second member may be arranged at the insulating spacer.

Optionally, the insulating spacer may be provided with a plurality of heat staking portions that are protruding, the plurality of heat staking portions may be spaced apart in the longitudinal direction, and the first members may include the plurality of heat staking portions, which may be fixed with ends of the plurality of conductive elements by heat staking.

Optionally, any two adjacent heat staking portions in the longitudinal direction may be provided with one of the plurality of conductive elements therebetween.

Optionally, before the plurality of heat staking portions are fixed by heat staking with the ends of the plurality of conductive elements, the plurality of heat staking portions may protrude from the plurality of conductive elements, and edges of protruding ends of the plurality of heat staking portions may be rounded.

Optionally, a cut may be arranged at an end of each of the plurality of heat staking portions close to the mounting surface.

Optionally, the plurality of conductive elements may comprise a plurality of signal conductive elements and a plurality of ground conductive elements, the plurality of ground conductive elements may be distributed among the plurality of signal conductive elements, and the second member may be made of a lossy material and may abut the plurality of ground conductive elements.

Optionally, the plurality of conductive elements may be arranged in two rows in the longitudinal direction on two sides of the insulating spacer, and the two sides of the insulating spacer may be opposite in a predetermined direction perpendicular to the longitudinal direction. The second member may comprise a body accommodated in the insulating spacer and a plurality of projections extending out of the insulating spacer from the two sides of the insulating spacer. The plurality of projections may abut intermediate portions of at least a portion of the plurality of conductive elements.

Optionally, the insulating spacer may be provided with a receiving space passing therethrough in a predetermined direction, and the second member may be disposed in the receiving space and may be removable in the predetermined direction.

Optionally, the receiving space may comprise a recess and a plurality of openings. The recess may be recessed from one of the two sides in the predetermined direction, and the plurality of openings extend from a bottom of the recess in the predetermined direction to the other of the two sides. The plurality of projections may comprise a plurality of first projections protruding from the insulating spacer via an opening of the recess and a plurality of second projections protruding from the insulating spacer via the plurality of openings in one-to-one correspondence.

Optionally, the length of the plurality of second projections may be greater than that of the plurality of first projections. Optionally, the length of the plurality of second projections may be greater than that of the plurality of openings.

Optionally, the plurality of first projections and/or the plurality of second projections may have reduced longitudinal dimension(s) in directions from projection roots to projection tips.

Optionally, a corner portion may be arranged at the connection of each of the plurality of second projections to the body.

Optionally, gaps may be arranged between the plurality of conductive elements and the insulating spacer, and the gaps may be uniform in length directions of the plurality of conductive elements.

Optionally, the second member may be configured for controlling the gaps.

Optionally, the gaps may range from 0.01 mm to 0.5 mm.

Optionally, a step may be arranged on the insulating spacer, the first members may be arranged on the step, and the ends of the plurality of conductive elements may abut the step.

Optionally, protrusions may be arranged at two ends of the insulating spacer in the longitudinal direction, and the insulating spacer may be connected to the insulating housing through the protrusions.

Optionally, the positioning assembly further may comprise a third member. The third member may contact the plurality of conductive elements at third locations, and the third member and the first members may be respectively arranged on two sides of the second member.

Optionally, the plurality of conductive elements may be fixed to the third member, and the third member may be fixed to the insulating spacer in the insulating housing. Latches opposite to each other may be respectively arranged on two ends of the insulating spacer in the longitudinal direction. Notches may be respectively arranged on two ends of the third member in the longitudinal direction. The latches may be disposed in the notches in a one-to-one correspondence.

Optionally, the third member may comprise a first subassembly housing and a second subassembly housing. The first subassembly housing may be provided with a recess having a smaller opening and a larger bottom, and the second subassembly housing may be provided with a protrusion engaged to the recess. The plurality of conductive elements may pass through the first subassembly housing and the second subassembly housing.

Optionally, the first members may exert first positioning forces at the first locations, the second member may exert second positioning forces at the second locations, and the third member may exert third positioning forces at the third locations. The first positioning forces and the third positioning forces may comprise pulling forces toward the interior of the insulating housing, and the second positioning forces may comprise pushing forces toward the exterior of the insulating housing.

Optionally, the electrical connector may be a right-angle electrical connector.

Optionally, the second member may be arranged between bending portions of the plurality of conductive elements and the mounting surface, and closer to the bending portion relatively.

Optionally, the electrical connector further may comprise an L-shaped insulating spacer extending along the plurality of conductive elements. The insulating spacer may be arranged in the insulating housing. Some of the plurality of conductive elements may be inner conductive elements arranged inside the insulating spacer and the others of the plurality of conductive elements may be outer conductive elements arranged outside the insulating spacer. Each of the plurality of conductive elements may comprise a contact end extending to the interfacing surface, a mounting end extending to the mounting surface, a first portion connecting the mounting end and the bending portion, and a second portion connecting the contact end and the bending portion. The second member may be arranged in the insulating spacer. The second member may abut the first portions of at least a portion of the inner conductive elements and at least a portion of the outer conductive elements, and the second member may extend beyond the first portions of the inner conductive elements in a direction away from the mounting surface.

Optionally, the first members may exert first positioning forces at the first locations, the second member may exert second positioning forces at the second locations. One of the first positioning forces and the second positioning forces may comprise pushing forces toward the exterior of the insulating housing, and the other of the first positioning forces and the second positioning forces may comprise pulling forces toward the interior of the insulating housing.

Some embodiments relate to an electrical connector. The electrical connector may comprise an insulating spacer provided with a plurality of heat staking portions on two sides thereof opposite to each other in a transverse direction, and a plurality of conductive elements arranged on the two sides of the insulating spacer and arranged in two rows in the longitudinal direction. The plurality of heat staking portions may protrude outwardly and may be spaced apart in a longitudinal direction perpendicular to the transverse direction. Any two adjacent heat staking portions in the longitudinal direction may be provided with one of the plurality of conductive elements therebetween. The plurality of heat staking portions may be fixed to ends of the plurality of conductive elements so that the heat staking portions may be used as first members. A second member may be arranged in the insulating spacer and may extend out of the two sides in the transverse direction. The second member may be sandwiched between at least a portion of the conductive elements in the two rows of conductive elements in the transverse direction.

Optionally, the electrical connector further may comprise an insulating housing having an interfacing surface and a mounting surface. The plurality of conductive elements may be held by the insulating housing. Each of the plurality of conductive elements may extend from the interfacing surface to the outside of the mounting surface. The longitudinal direction may be parallel to the interfacing surface and the mounting surface. The insulating spacer may be arranged in the insulating housing.

Optionally, protrusions may be arranged in a middle of the insulating spacer and at two ends thereof in the longitudinal direction, and the insulating spacer may be connected to the insulating housing by the protrusions.

Optionally, the electrical connector may be a right-angle electrical connector.

Optionally, the second member may be arranged between bending portions of the plurality of conductive elements and the mounting surface, and closer to the bending portion relatively.

Optionally, the insulating spacer may be L-shaped. One row of the plurality of conductive elements may be arranged inside the insulating spacer and the other row of the plurality of conductive elements may be arranged outside the insulating spacer. Each of the plurality of conductive elements may comprise a contact end extending to the interfacing surface, a mounting end extending out of the mounting surface, a first portion connecting the mounting end and the bending portion, and a second portion connecting the contact end and the bending portion. The second member may abut the first portions of at least a portion of the one row of the plurality of conductive elements and at least a portion of the other row of the plurality of conductive elements. The second member may extend beyond the first portions of the one row of the plurality of conductive elements in a direction away from the mounting surface.

Optionally, the plurality of conductive elements may comprise a plurality of signal conductive elements and a plurality of ground conductive elements. The plurality of ground conductive elements may be distributed among the plurality of signal conductive elements. The second member may be made of a lossy material and may abut the plurality of ground conductive elements.

Optionally, second member may comprise a body accommodated in the insulating spacer, and a plurality of projections extending out of the insulating spacer from the two sides of the insulating spacer. The plurality of projections may abut intermediate portions of at least a portion of the plurality of conductive elements.

Optionally, the insulating spacer may be provided with a receiving space extending in the transverse direction. The second member may be disposed in the receiving space and may be removable in the transverse direction.

Optionally, the receiving space may comprise a recess and a plurality of openings. The recess may be recessed from one of the two sides in the transverse direction, and the plurality of openings may extend from a bottom of the recess in the transverse direction to the other of the two sides. The plurality of projections may comprise a plurality of first projections protruding from the insulating spacer via an opening of the recess and a plurality of second projections protruding from the insulating spacer via the plurality of openings in one-to-one correspondence.

Optionally, the length of the plurality of second projections may be greater than that of the plurality of first projections.

Optionally, the length of the plurality of second projections may be greater than that of the plurality of openings.

Optionally, the plurality of first projections and/or the plurality of second projections may have a reduced longitudinal dimension(s) in directions from projection roots to projection tips.

Optionally, a corner portion may be arranged at the connection of each of the plurality of second projections to the body.

Optionally, gaps may be arranged between the plurality of conductive elements and the insulating spacer, and the gaps may be uniform in length directions of the plurality of conductive elements.

Optionally, the second member may be configured for controlling the gap.

Optionally, the gaps may range from 0.01 mm to 0.5 mm.

Optionally, the electrical connector further may comprise a third member. The third member may be configured to fix the plurality of conductive elements to the insulating spacer. The third member and the heat staking portions may be respectively arranged on two sides of the second member.

Optionally, the plurality of conductive elements may be fixed to the third member. Latches opposite to each other may be respectively arranged on two ends of the insulating spacer in the longitudinal direction, notches may be respectively arranged on two ends of the third member in the longitudinal direction, and the latches may be disposed in the notches in a one-to-one correspondence.

Optionally, the third member may comprise a first subassembly housing and a second subassembly housing. The first subassembly housing may be provided with a groove having a smaller opening and a larger bottom, the second subassembly housing may be provided with a protrusion engaged to the groove, and the plurality of conductive elements may pass through the first subassembly housing and the second subassembly housing.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures is represented by a like numeral. For purposes of clarity, not every component may be labeled in every drawing. In the drawings:

FIG. 1 is a rear, side perspective view of an electrical connector, according to some embodiments;

FIG. 2 is a front, bottom perspective view of the electrical connector of FIG. 1;

FIG. 3 is a cross-sectional perspective view of the electrical connector of FIG. 1 taken by a plane perpendicular to the X-X direction;

FIG. 4A is a cross-sectional perspective view of the electrical connector of FIG. 1 taken by a plane perpendicular to the Z-Z direction;

FIG. 4B is a an enlarged view of a portion of the electrical connector circled in FIG. 4A;

FIG. 5 is a rear, side perspective view of an internal structure of the electrical connector of FIG. 1, with an insulating housing and conductive elements hidden;

FIG. 6 is a front, top perspective view of the internal structure of FIG. 5;

FIG. 7 is a perspective view of the internal structure of FIG. 6, with a third member hidden;

FIG. 8 is a cross-sectional perspective view of the internal structure of FIG. 7 taken by a plane perpendicular to the X-X direction;

FIG. 9 is a front perspective view of an insulating spacer of the electrical connector of FIG. 1; and

FIG. 10 is a perspective view of a second member of the electrical connector of FIG. 1.

The above accompanying drawings include the following reference numerals:

100—insulating housing, 110—interfacing surface, 120—mounting surface, 200—conductive element, 200a—conductive element on the outer side, 200b—conductive element on the inner side, 201—contact end, 202—mounting end, 203—bending portion, 204—first portion, 205—second portion, 210—signal conductive element, 220—ground conductive element, 300—first member, 310—heat staking portion, 311—edge, 312—cut, 400—second member, 410—body, 420—projection, 421—first projection, 422—second projection, 430—corner portion, 500—insulating spacer, 501—vertical portion, 502—horizontal portion, 510—receiving space, 511—recess, 512—opening, 520—latch, 530—protrusions, 540—edge, 550—step, 600—third member, 601—notch, 610—first subassembly housing, 611—groove, 620—second subassembly housing, and 621—protrusion.

### DETAILED DESCRIPTION

The Inventors have recognized and appreciated connector designs that can support high speed signals despite manufacturing variations. Designs as described herein that tolerate manufacturing variations may be less expensive to manufacture and/or more robust in operation. Conventional connectors may have components designed to fit together, but will have gaps in various sizes and shapes between the components, which may be caused by variations in manufacturing and assembling the components. Moreover, the sizes and shapes of the gaps may change during use or transportation (e.g., the conductive elements may vibrate with the system).

The inventors have recognized and appreciated that the size of gaps relative to a nominal size accounted for in the connector design may affect the quality of signal transmission. For example, larger gaps may lead to higher impedance and therefore worse signal integrity, while smaller gaps may increase resonance, which can create crosstalk and also deteriorate signal integrity. The impact of variations may be more pronounced for high speed signals, such as signals that have primary frequency components in the GHz range. Accordingly, if there is conventional variation in the gaps, uncertainty may be introduced about the performances of the systems employing the connectors. For example, connectors of the same type may have different performances due to these variations, causing systems using the connectors to perform undesirably differently. On the other hand, having the components manufactured with more precise dimensions would complicate the process and increase costs.

The Inventors have recognized simple and low cost manufacturing techniques that may control gaps to provide connectors sufficient signal integrity to pass signals at high speed. These techniques may be incorporated into a connector with predetermined mating and mounting interfaces, for example, to improve the performance of the connector or to enable the connector to operate at higher frequencies. Such techniques may be beneficial to enable connectors according to an industry standard specification, for example, to meet an updated specification. As a specific example, the techniques may be applied to a connector designed to meet a PCIe Gen 4 specification to simply upgrade the connector design to meet PCIe Gen 5 specification.

Techniques as described herein may provide gaps in controlled sizes and shapes without complicating manufacturing. A connector may include a housing having an interfacing surface, a mounting surface, and a slot at the interfacing surface and elongating in a longitudinal direction. The slot may be configured to receive a mating component such as an electronic card or a plug connector. Conductive elements may be held in the housing in first and second rows parallel to the longitudinal direction. Each conductive element may include a mating end having a mating contact portion curving into the slot, and a mounting end opposite the mating end and extending out of the mounting surface of the housing.

A spacer may be disposed in the housing and between the first and second rows of conductive elements. The spacer may include features configured to prevent the spacer form moving relatively to the housing in the longitudinal direction. The spacer may comprise first members contacting the conductive elements at first locations so as to hold the first locations of the conductive elements in position. Optionally, the first members may be formed by heat staking after the conductive elements are positioned to the spacer. Optionally, each first member may at least partially wrap a respective conductive element at the mounting end.

A second member may be removably disposed in the spacer. The second member may have projections extending beyond the spacer to contact selected conductive elements at second locations. The second member may have a length that is greater than a length of the spacer in a transverse direction perpendicular to the longitudinal direction, such that gaps between the spacer and the first and second rows of conductive elements may be at least partially determined by a difference between the lengths of the second member and the spacer. Optionally, the second member may be lossy and configured to electrically connect conductive elements configured for grounding.

The conductive elements may be held in the first and second rows by first and second subassembly housings, respectively. The first and second subassembly housings may hold the conductive elements at third locations that are between the mating ends and the second locations of the conductive elements. The first and second subassembly housings may be connected to the spacer. Optionally, the first and second subassembly housings may have notches configured to receive latches of the spacer.

Compared with an existing electrical connector, the electrical connectors provided by the embodiments of the present disclosure may effectively reduce the crosstalk, thereby improving the signal integrity. The electrical connectors may support requirements of, for example, PCIE Gen 5 (the fifth generation of peripheral component interconnection standard) for high-speed performance. Moreover, the electrical connectors may have backward compatibility, for example, the electrical connectors may also support requirements of PCIE Gen 3 and PCIE Gen 4 for high-speed performance.

The inventors have recognized and appreciated that various techniques may be used alone or in any proper combination to improve signal integrity of a high-speed interconnection system. The technologies provided in the present disclosure may be particularly advantageous in a right-angle interconnection system. The electrical connectors using these technologies can effectively improve signal integrity in the right-angle interconnection system.

In the following description, numerous details are provided to enable a thorough understanding of the present disclosure. However, a person skilled in the art would understand that the following description only exemplarily shows the preferred embodiments of the present disclosure, and the present disclosure may be implemented without one or more such details. In addition, in order to avoid confusion with the present disclosure, some technical features known in the art have not been described in detail.

For clear and concise description, a vertical direction Z-Z, a longitudinal direction X-X, and a transverse direction Y-Y are defined. The vertical direction Z-Z, the longitudinal direction X-X and the transverse direction Y-Y may be perpendicular to one another. The vertical direction Z-Z refers to a height direction of the electrical connector. The longitudinal direction X-X refers to a length direction of the electrical connector. The transverse direction Y-Y refers to a width direction of the electrical connector.

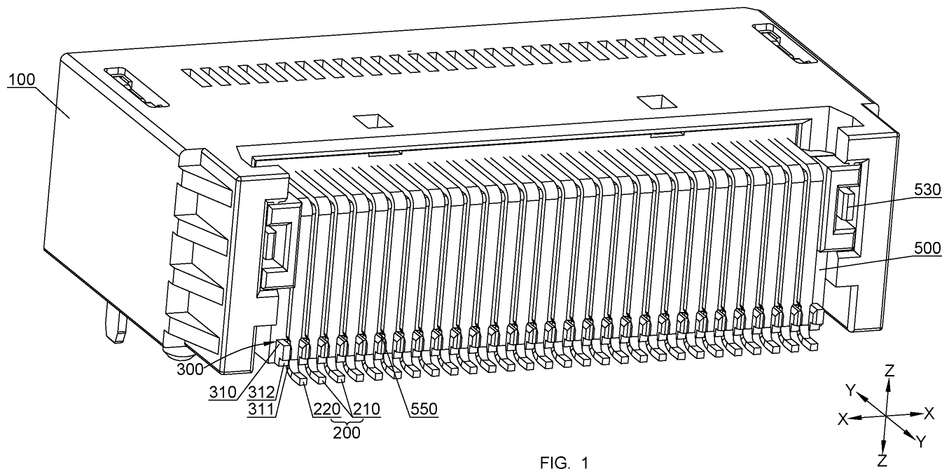

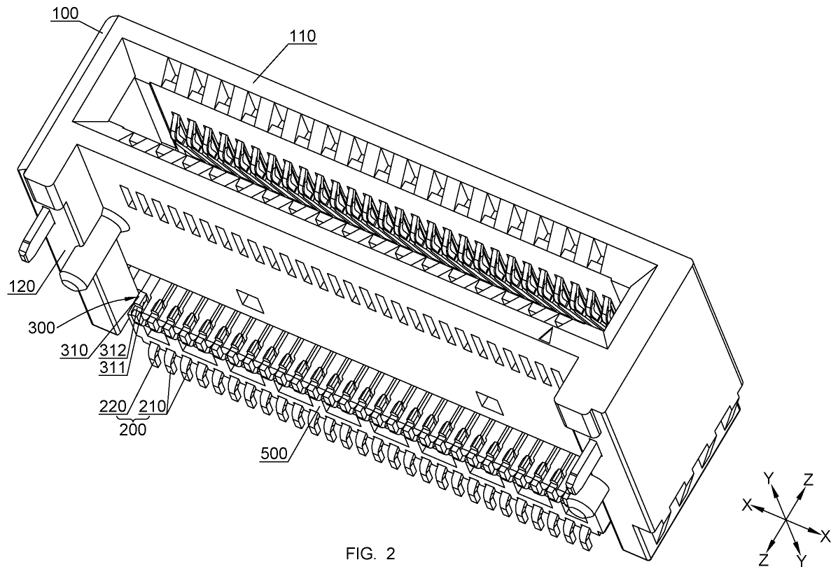

As shown in FIGS. 1-4B, an electrical connector may include an insulating housing 100, a positioning assembly, and a plurality of conductive elements 200. As illustrated, the electrical connector may be a right-angle electrical connector. In some embodiments (not shown), the electrical connector may be a vertical electrical connector or the like.

The insulating housing 100 may have an interfacing surface 110 and a mounting surface 120. The longitudinal direction X-X may be parallel to the interfacing surface 110 and the mounting surface 120. In an embodiment where the electrical connector is the right-angle electrical connector, the interfacing surface 110 and the mounting surface 120 may be perpendicular to each other. In other types of electrical connectors, such as a vertical connector, the interfacing surface 110 and the mounting surface 120 may be opposite to each other. However, regardless of the type of the electrical connector, the interfacing surface 110 and the mounting surface 120 in various electrical connectors basically function in similar ways. The insulating housing 100 may be molded from an insulating material such as plastics. The insulating housing 100 is usually an integrated member.

The plurality of conductive elements 200 may be held by the insulating housing 100. The plurality of conductive elements 200 may be arranged in a row in the longitudinal direction X-X. The number of rows is not limited, and includes, but is not limited to, one, two or more, etc. In an embodiment where the number of rows is multiple, multiple rows of the conductive elements 200 may be spaced apart in a predetermined direction. The predetermined direction may be perpendicular to the longitudinal direction X-X. The predetermined direction may be any direction in the plane constructed by the vertical direction Z-Z and the transverse direction Y-Y.

Adjacent conductive elements 200 in each row may be spaced apart from each other to ensure electrical insulation between adjacent conductive elements 200. The conductive elements 200 may be made of a conductive material such as metal. The conductive elements 200 may be elongated one-piece members. The conductive elements 200 each may include a contact end 201 and a mounting end 202 at two ends of a respective conductive element in an extension direction thereof. The portion between the contact end 201 and the mounting end 202 may be referred to as an intermediate portion. The contact end 201 may be electrically connected to an electrical component such as an electronic card or corresponding conductive elements on a mated electrical connector. The mounting end 202 may be electrically connected to a printed circuit board by soldering or any other proper manner, thereby electrically connecting with the printed circuit board. In this way, the electrical connector can electrically connect an electrical component to a printed circuit board by the conductive elements 200, thereby implementing interconnection of circuits on the electrical component and circuits on the printed circuit board. The contact ends 201 of the conductive elements 200 may extend to the interfacing surface 110. Exemplarily, the interfacing surface 110 of the electrical connector may be provided with a suitable interface. The interface includes, but is not limited to a slot. The slot may receive electrical components such as an electronic card and a mated electrical connector. The mounting ends 202 of the conductive elements 200 may extend out of the mounting surface 120. The mounting surface 120 may face an element such as a printed circuit board.

The positioning assembly may be configured to position the conductive elements 200, thereby effectively fixing the conductive elements 200. The positioning assembly includes, but is not limited to, a latch or a protrusion, etc. In an embodiment, a positioning assembly includes first members 300 and a second member 400. The first members 300 may contact the plurality of conductive elements 200 at first locations through one or more manners, such as clamping, protrusion connection, bonding, soldering, and screw connection. For each of the conductive elements 200, there may be a first location which is close to or positioned at the contact end 201 or mounting end 202 thereof, or there may be multiple first locations, e.g., two, which are respectively close to or positioned at the contact end 201 and the mounting end 202 thereof. The second member 400 may contact at least a portion of the plurality of conductive elements 200 at second locations (e.g., intermediate portions of conductive elements). The first locations and the second locations may be spaced apart in the extension direction of the conductive elements 200. Those of the conductive elements 200 positioned by the second member 400 may be a specific type of conductive elements, such as ground conductive elements or signal conductive elements, or may be high-speed signal conductive elements among the signal conductive elements. When the conductive elements positioned by the second member 400 are signal conductive elements, the second member 400 may be made of an insulating material. When the conductive elements positioned by the second member 400 are ground conductive elements, the second member 400 may be made of an insulating material, a conductive material, or a lossy material. When the second member 400 is made of the insulating material, the second member 400 may simultaneously position the signal conductive elements and the ground conductive elements. Optionally, the signal conductive elements and the ground conductive elements may be respectively provided with different second members made of different materials, and different second members may be configured to respectively position the signal conductive elements and the ground conductive elements.

In the electrical connectors according to embodiments of the present disclosure, the conductive elements 200 can be effectively fixed by the first members 300 contacting the conductive elements 200 at the first locations, so as not to be shifted due to installation or transportation, etc. In this way, the conductive elements 200 may be held at desired positions and desired gaps may be maintained between the conductive elements 200 and other components (e.g., the insulating spacer 500 mentioned below). Further, the second member 400 may contact a portion of the conductive elements 200 at second locations, that is, the portion of the conductive elements each may be positioned at two portions, so that they have better position holding capability. Those skilled in the art may select which type of conductive elements are positioned simultaneously by the first members 300 and the second member 400 according to needs or have the conductive elements 200 positioned simultaneously by both positioning members.

By suitably designing the structures of the first members 300 and the second member 400, the conductive elements 200 may be held at desired positions, so that the gaps between the conductive elements 200 and the insulating spacer 500 may be precisely controlled. Therefore, the crosstalk may be effectively reduced, and the signal integrity may be improved. Mass-produced electrical connectors have relatively good consistency.

Because a portion of the conductive elements 200 may be positioned simultaneously by the first members 300 and the second member 400, the portion of the conductive elements may have be positioned more stably. The first members 300 may exert first positioning forces on the conductive elements 200 at the first locations and the second member 400 may exert second positioning forces on the conductive elements 200 at second locations. Preferably, one of the first positioning forces and the second positioning forces includes pushing forces toward the outside of the insulating housing 100, and the other of the first positioning forces and the second positioning forces includes pulling forces toward the inside of the insulating housing. Exemplarily, when the positioned portions are at or adjacent to the ends of the conductive elements, the positioning forces exerted on the portions may include pulling forces toward the inside of the insulating housing 100. When the positioned portions are at the intermediate portions of the conductive elements, the positioning forces exerted on the portions may include pushing forces toward the outside of the insulating housing 100. By exerting positioning forces in at least two directions on the same conductive element, the conductive elements may have better position holding capability, and the position of the conductive elements may be precisely controlled by suitably designing the structures of the positioning members.

The contact ends 201 of the conductive elements 200 may be electrically contacted with the mated electrical connector or the electronic card inserted into the electrical connector. The contact ends 201 may exert forces on the mated electrical connector or the electronic card to form reliable electrical contacts, and therefore it may be desirable that the contact ends 201 be biased or bent toward the interior of the insulating housing 100. If the first locations are closer to the contact ends 201 than the second locations, the first members 300 may exert pulling forces toward the inside of the insulating housing 100 at the first locations, which is beneficial to form reliable electrical contacts between the contact ends 201 and the mated electrical connector or the electronic card. The printed circuit board to be connected with the mounting ends 202 tends to be miniaturized, and mounting space thereon is limited. If the first locations are closer to the mounting ends 202 than the second locations, the first members 300 may exert pulling forces toward the inside of the insulating housing 100 at the first locations, which may be beneficial for the mounting ends 202 to occupy smaller mounting space on the printed circuit board. When the second member 400 exerts pushing forces toward the outside at second locations in the intermediate portions of the conductive elements, entire strips of the conductive elements 200 may be stably maintained at desired positions and have extremely excellent position holding capability, and the positions of the strips of the conductive elements 200 may be directly and efficiently adjusted by adjusting the dimension or construction of the second member 400.

Exemplarily, the electrical connector may further include an insulating spacer 500. The first members 300 and the second member 400 may be respectively arranged on the insulating spacer 500 by soldering, adhesion, insertion, molding, or any proper manner. The insulating spacer 500 may be formed by an insulating material such as plastic through a molding process. The materials of the first members 300 and the second member 400 may be the same or different from that of the insulating spacer 500. The positional relationship between the first members 300 and the second member 400 may be more stable by disposing both of the first members 300 and the second member 400 on the insulating spacer 500, so that the positioning effect on the conductive elements 200 may be better, thereby ensuring better integrity of the transmitted signal.

In other embodiments, both the first members 300 and the second member 400 may be arranged on the insulating housing 100. Alternatively or additionally, some of the first members 300 and the second member 400 may be arranged on the insulating spacer 500, and others are arranged on the insulating housing 100.

Exemplarily, the second member 400 may abut the intermediate portions of at least a portion of the plurality of conductive elements 200 toward the outside of the insulating housing 100. In the embodiment where the electrical connector is a right-angle electrical connector, the conductive elements 200 may be bent in L-shapes. The second member 400 may be arranged between bending portions 203 of the plurality of conductive elements 200 and the mounting surface 120. The second member 400 may be closer to the bending portions 203. The mounting ends 202 of the conductive elements 200 at the mounting surface 120 may be soldered to the printed circuit board. The gaps at these positions closer to the bending portions 203 can be controlled by arranging the second member 400. Accordingly, integrity of the transmitted signal may be improved.

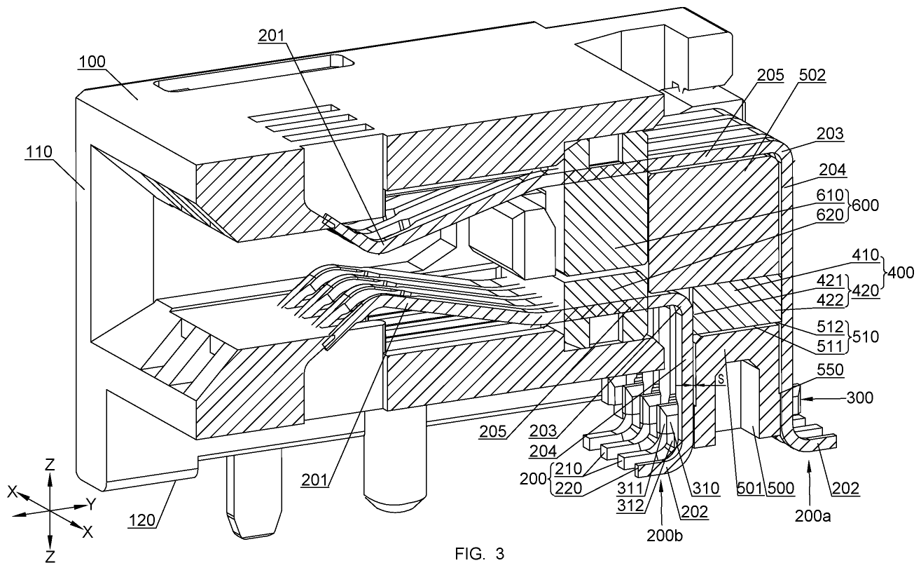

Exemplarily, the second member 400 may be configured to control gaps S between the plurality of conductive elements 200 and the insulating spacer 500. The gaps S are preferably uniform in length directions of the plurality of conductive elements 200. In this way, the integrity of the transmitted signal may be better. For the right-angle electrical connector, each conductive element 200 is typically bent to form the bending portion 203, as shown in FIG. 3. The bending portion 203 may be in a right-angle shape. In a right-angle electrical connector, the insulating spacer 500 may be in an L-shape. Therefore, each gap S may be in an L-shape in the length direction of respective conductive element 200. Each gap S may include a first gap and a second gap. The first gap may extend in a vertical direction Z-Z and the second gap may extend in a transverse direction Y-Y. Although the gap S is marked in the figures only between one of conductive elements 200b on the inner side and the insulating spacer 500, it should be appreciated that there are also gaps between the conductive elements 200a on the outer side and the insulating spacer 500 which are not marked. The conductive elements 200a on the outer side refer to those conductive elements that semi-enclose the insulating spacer 500, while the conductive elements 200b on the inner side refer to those conductive elements that are semi-enclosed by the insulating spacer 500. In FIG. 3, the conductive elements 200a on the outer side are longer than the conductive elements 200 on the inner side and are arranged to the upper right of the conductive elements 200b on the inner side. The insulating spacer 500 is arranged between conductive elements 200a on the outer side and conductive elements 200b on the inner side. The second member 400 may extend out of two sides of the insulating spacer 500 and respectively abut the conductive elements 200a on the outer side and the conductive elements 200b on the outer side, so that the gaps between the conductive elements 200a on the outer side and the insulating spacer 500 and the gaps between the conductive elements 200b on the inner side and the insulating spacer 500 may be respectively controlled.

Exemplarily, for a vertical electrical connector, the conductive elements on two sides of the insulating spacer may be in shape of straight lines. The insulating spacer may be cuboid-shaped. The conductive elements may be symmetrically distributed on two sides of the insulating spacer, and the second member may also be configured to control the gaps between the conductive elements and the insulating spacer. For example, the second member may extend out of two sides of the insulating spacer and respectively abut the conductive elements on two sides.

Exemplarily, the gaps S may range from 0.01 mm to 0.5 mm. For example, the gaps S may be 0.01 mm, 0.25 mm, or 0.5 mm, etc. Larger gaps S cause higher impedances of conductive elements 200. And, the larger gaps S further cause the dimension of the electrical connector to be increased, which goes against a trend of miniaturization. Smaller gaps S cause lower impedance of conductive elements 200, which may cause a resonance phenomenon. Such resonance may interfere with signals, causing the signal integrity of the electrical connector to fail to meet the crosstalk spec. of the PCIE Card Electromechanical (CEM) GEN5.

Still referring to FIG. 3, each conductive element 200 may further include a first portion 204 connecting the mounting end 202 and the bending portion 203 and a second portion 205 connecting the contact end 201 and the bending portion 203. The second member 400 may abut the first portions 204 of the conductive elements 200. Specifically, for the embodiment shown in FIG. 3, the second member 400 may abut, in the transverse direction, the first portions 204 of the conductive elements 200a on the outer side and the first portions 204 of the conductive elements 200b on the inner side. The second member 400 may exceed the first portions 204 of the conductive elements 200b on the inner side in a direction away from the mounting surface 120. The second member 400 may be arranged in one arm of the L-shaped insulating spacer 500, for example, in a vertical portion 501 of the insulating spacer 500. The second member 400 may abut the other arm of the L-shaped insulating spacer 500, for example, a horizontal portion 502 of the insulating spacer 500. As illustrated, the vertical portion 501 is perpendicular to the mounting surface 120 and the horizontal portion 502 is parallel to the mounting surface 120. The second member 400 may abut a surface of the horizontal portion 502 facing the mounting surface 120. Because the second member 400 extends out of the insulating spacer 500 toward the conductive elements 200b on the inner side, the portion of the second member 400 outside the insulating spacer 500 may position the horizontal portion 502 of the insulating spacer 500, so that the gap between the horizontal portion 502 and the second portions 205 of the conductive elements 200b on the inner side may also be adjusted to some extent.

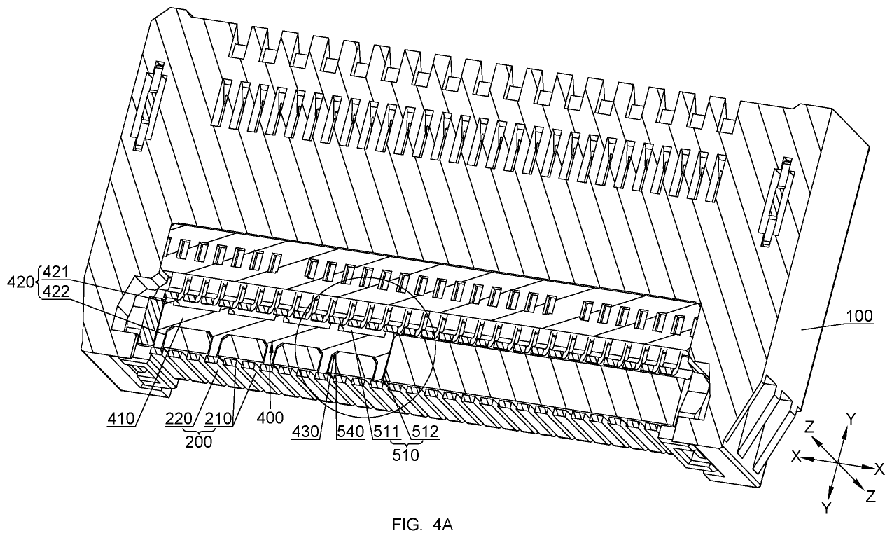

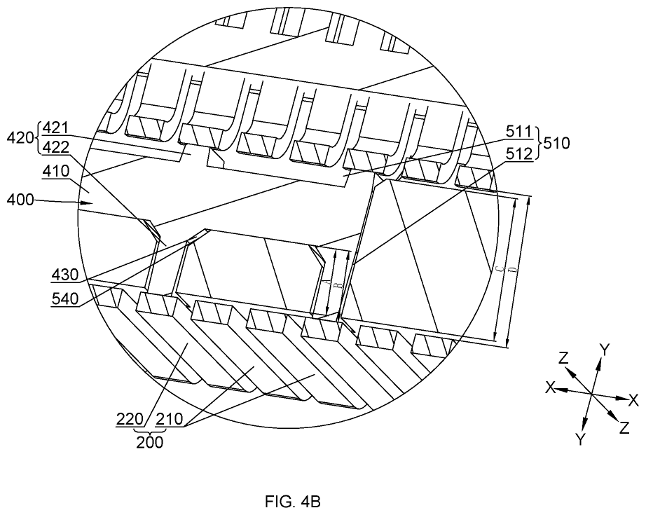

In the transverse direction Y-Y, the second member 400 may pass through the insulating spacer 500. The total length D of the second member 400 may be greater than the length C of the vertical portion 501, as shown in FIG. 4B. In this way, when the second member 400 is mounted in place, the second member 400 may extend out of the insulating spacer 500 from two sides in the transverse direction. The spacing between each row of conductive elements 200 abutting on the second member 400 and the insulating spacer 500 may be half of the sum D-C of the spacings between the two rows of conductive elements 200 respectively and the insulating spacers 500, that is, equal to (D-C)/2. The arrangement of the spacing between each row of conductive elements 200 and the insulating spacer 500 is further described below in conjunction with a preferred embodiment. Optionally, the second member 400 may further self-adjust its position in the insulating spacer 500 in the transverse direction based on the forces exerted on the second member 400 by the conductive elements 200a on the outer side and the conductive elements 200b on the inner side. Optionally, the position of the second member 400 in the insulating spacer 500 is fixed and non-adjustable. In this way, when the second member 400 is fixed, the sizes of the gaps between the conductive elements 200a on the outer side and the insulating spacer 500 and between the conductive elements 200b on the inner side and the insulating spacer 500 can be determined.

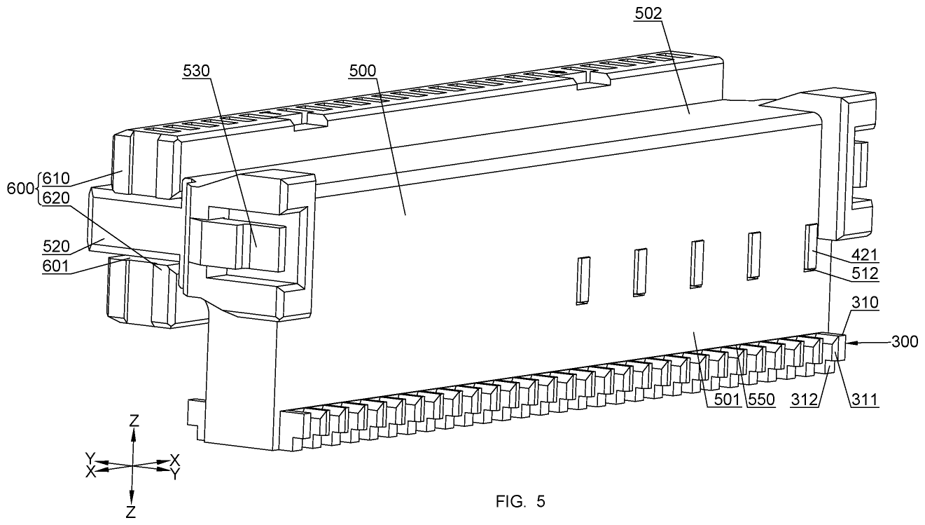

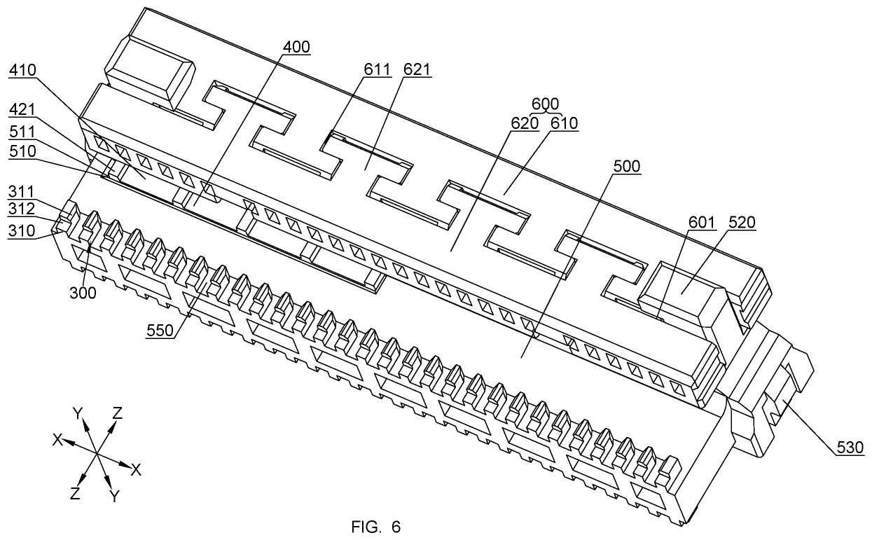

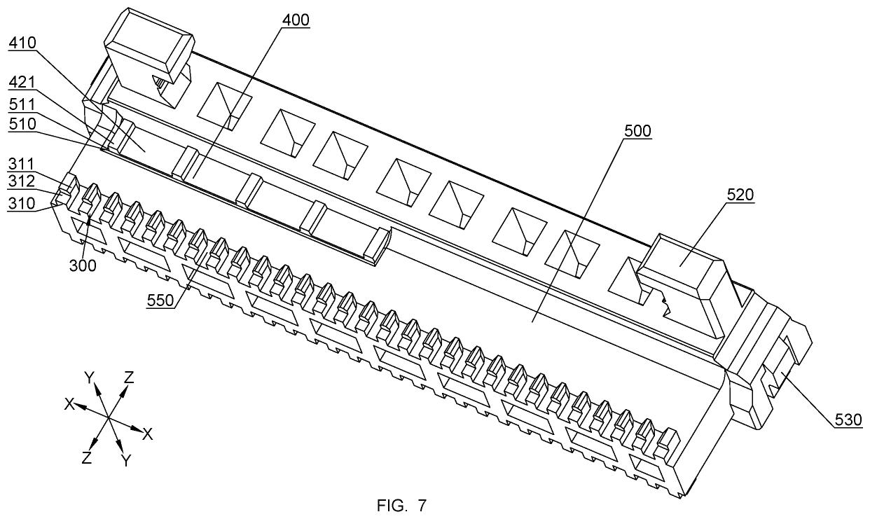

The insulating spacer 500 may be arranged in the insulating housing 100 by soldering, adhesion, insertion or any proper manner. Exemplarily, as shown in FIGS. 5 to 8, protrusions 530 may be arranged on two ends of the insulating spacer 500 in the longitudinal direction X-X. Slots adapted to the protrusions 530 may be arranged on the insulating housing 100. The insulating spacer 500 may be connected to the slots of the insulating housing 100 through the protrusions 530. With such arrangement, the connection of the insulating spacer 500 and the insulating housing 100 is simple in structure, low in manufacturing costs, and convenient to mount and dismount.

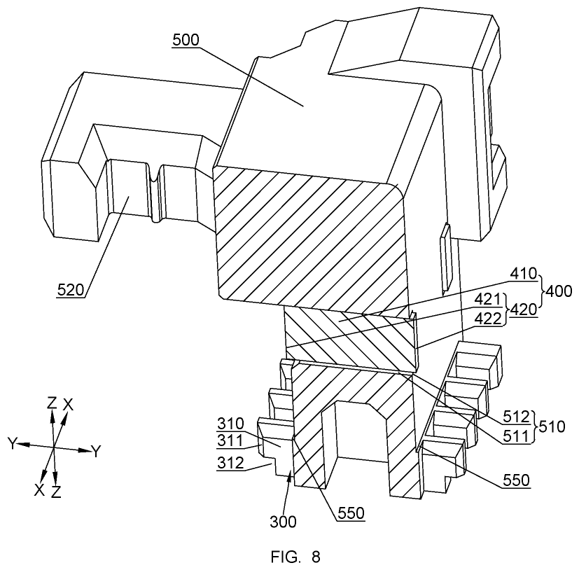

Exemplarily, as shown FIGS. 5 to 9 such as FIG. 8, a step(s) 550 may be arranged on the insulating spacer 500. The step(s) 550 may protrude outward from the side of the insulating spacer 500. As illustrated, steps 550 are arranged on two sides of the insulating spacer 500. The two sides of the insulating spacer 500 may face the two rows of conductive elements 200 respectively. The two sides may be arranged opposite to each other in the transverse direction Y-Y. The first members 300 may be arranged on the steps 550. The first members 300 may be separated from each other, and the first members 300 may share the step 550. The ends of the plurality of conductive elements 200 (e.g., the mounting ends 202 as illustrated in the figures) may abut the step 550.

Exemplarily, the electrical connector may further include a third member 600. The third member 600 may contact the plurality of conductive elements 200 at third locations. The third member 600 and the first members 300 may be respectively arranged on two sides of the second member 400. The third member 600 may fix the plurality of conductive elements 200 to the insulating spacer 500 at the third locations. The third locations may be close to or at the contact ends 201 of the conductive elements 200. The conductive elements 200 may be further positioned by arranging the third member 600, and thereby integrity of the transmitted signal is further improved.

As previously described, the first members 300 may exert first positioning forces at first locations and the second member 400 may exert second positioning forces at second locations. The third member 600 may exert third positioning forces on the conductive elements 200 at third locations. The first positioning forces and the third positioning forces may include pulling forces toward the inside of the insulating housing 100, and the second positioning forces may include pushing forces toward the outside of the insulating housing 100. The first members 300 and the third member 600 may respectively exert pulling forces on two sides of the second member 400, the second member 400 may exerts pushing force toward the outside at the second locations in the intermediate portions of the conductive elements 200, entire strips of the conductive elements 200 may be stably maintained at desired positions and have extremely excellent position holding capability, and the positions of the strips of the conductive elements 200 may be directly and efficiently adjusted by adjusting the size or construction of the second member 400.

Exemplarily, the plurality of conductive elements 200 may be fixed to the third member 600 by insertion or any proper manner. The third member 600 may be fixed on the insulating spacer 500. Latches 520 opposite to each other may be respectively arranged on the two ends of the insulating spacer 500 in the longitudinal direction X-X. Notches 601 may be respectively arranged on two ends of the third member 600 in the longitudinal direction. The latches 520 may be disposed in the notches 601 in one-to-one correspondence. With such arrangement, the electrical connector has concise structure and low manufacturing costs.

Exemplarily, the third member 600 may include a first subassembly housing 610 and a second subassembly housing 620. First grooves 611 may be arranged in the first subassembly housing 610. The first grooves 611 each may be in a shape with a smaller opening and a larger bottom. Protrusions 621 may be arranged on the second subassembly housing 620. The protrusions 621 may engage the grooves 611. The conductive elements 200 may pass through the first subassembly housing 610 and the second subassembly housing 620 correspondingly. With such arrangement, the third member 600 may be convenient to mount and dismount.

In other embodiments, the plurality of conductive elements 200 may optionally be clamped between the third member 600 and the insulating spacer 500. Alternatively or additionally, the third member 600 may fix the plurality of conductive elements 200 to the insulating spacer 500 by any other proper manner.

Exemplarily, the plurality of conductive elements 200 may include a plurality of signal conductive elements 210 and a plurality of ground conductive elements 220. The plurality of ground conductive elements 220 may be distributed among the plurality of signal conductive elements 210. The plurality of signal conductive elements 210 and the plurality of ground conductive elements 220 may be arranged according to various required styles. In the embodiments shown in the figures, the signal conductive elements 210 appear in pairs to form differential signal conductive element pairs for transmitting differential signals. The ground conductive elements 220 may be located between any two adjacent pairs of signal conductive elements 210. The differential signal conductive element pairs may be used for transmitting high-speed signals to reduce crosstalk. Optionally, each signal conductive element 210 may also be used for transmitting a single-ended signal.

Exemplarily, the second member 400 may be made of a lossy material. The second member 400 may abut multiple ground conductive elements 220. Materials that dissipate a sufficient portion of the electromagnetic energy interacting with that material to appreciably impact the performance of a connector may be regarded as lossy. A meaningful impact results from attenuation over a frequency range of interest for a connector. In some configurations, lossy material may suppress resonances within ground structures of the connector and the frequency range of interest may include the natural frequency of the resonant structure, without the lossy material in place. In other configurations, the frequency range of interest may be all or part of the operating frequency range of the connector.

For testing whether a material is lossy, the material may be tested over a frequency range that may be smaller than or different from the frequency range of interest of the connector in which the material is used. For example, the test frequency range may extend from 10 GHz to 25 GHz or 1 GHz to 5 GHz. Alternatively, lossy material may be identified from measurements made at a single frequency, such as 10 GHz or 15 GHz.

Loss may result from interaction of an electric field component of electromagnetic energy with the material, in which case the material may be termed electrically lossy. Alternatively or additionally, loss may result from interaction of a magnetic field component of the electromagnetic energy with the material, in which case the material may be termed magnetically lossy.

Electrically lossy materials can be formed from lossy dielectric and/or poorly conductive materials. Electrically lossy material can be formed from material traditionally regarded as dielectric materials, such as those that have an electric loss tangent greater than approximately 0.01, greater than 0.05, or between 0.01 and 0.2 in the frequency range of interest. The “electric loss tangent” is the ratio of the imaginary part to the real part of the complex electrical permittivity of the material.

Electrically lossy materials can also be formed from materials that are generally thought of as conductors, but are relatively poor conductors over the frequency range of interest. These materials may conduct, but with some loss, over the frequency range of interest such that the material conducts more poorly than conductors of an electrical connector, but better than an insulator used in the connector. Such materials may contain conductive particles or regions that are sufficiently dispersed that they do not provide high conductivity or otherwise are prepared with properties that lead to a relatively weak bulk conductivity compared to a good conductor such as pure copper over the frequency range of interest. Die cast metals or poorly conductive metal alloys, for example, may provide sufficient loss in some configurations.

Electrically lossy materials of this type typically have a bulk conductivity of about 1 Siemen/meter to about 100,000 Siemens/meter, or about 1 Siemen/meter to about 30,000 Siemens/meter, or 1 Siemen/meter to about 10,000 Siemens/meter. In some embodiments, material with a bulk conductivity of between about 1 Siemens/meter and about 500 Siemens/meter may be used. As a specific example, material with a conductivity between about 50 Siemens/meter and 300 Siemens/meter may be used. However, it should be appreciated that the conductivity of the material may be selected empirically or through electrical simulation using known simulation tools to determine a conductivity that provides suitable signal integrity (SI) characteristics in a connector. The measured or simulated SI characteristics may be, for example, low cross talk in combination with a low signal path attenuation or insertion loss, or a low insertion loss deviation as a function of frequency.

It should also be appreciated that a lossy member need not have uniform properties over its entire volume. A lossy member, for example, may have an insulative skin or a conductive core, for example. A member may be identified as lossy if its properties on average in the regions that interact with electromagnetic energy sufficiently attenuate the electromagnetic energy.

In some embodiments, lossy material is formed by adding to a binder a filler that contains particles. In such an embodiment, a lossy member may be formed by molding or otherwise shaping the binder with filler into a desired form. The lossy material may be molded over and/or through openings in conductors, which may be ground conductors or shields of the connector. Molding lossy material over or through openings in conductors may ensure intimate contact between the lossy material and the conductor, which may reduce the possibility that the conductor will support a resonance at a frequency of interest. This intimate contact may, but need not, result in an Ohmic contact between the lossy material and the conductor.

Alternatively or additionally, the lossy material may be molded over or injected into insulative material, or vice versa, such as in a two shot molding operation. The lossy material may press against or be positioned sufficiently near a ground conductor that there is appreciable coupling to a ground conductor. Intimate contact is not a requirement for electrical coupling between lossy material and conductors, as sufficient electrical coupling, such as capacitive coupling, between a lossy member and conductors may yield the desired result. For example, in some scenarios, 100 pF of coupling between a lossy member and a ground conductor may provide an appreciable impact on the suppression of resonance in the ground conductor. In other examples with frequencies in the range of approximately 10 GHz or higher, a reduction in the amount of electromagnetic energy in conductors may be provided by sufficient capacitive coupling between a lossy material and the conductor with a mutual capacitance of at least about 0.005 pF, such as in a range between about 0.01 pF to about 100 pF, between about 0.01 pF to about 10 pF, or between about 0.01 pF to about 1 pF. To determine whether lossy material is coupled to conductors, coupling may be measured at a test frequency, such as 15 GHz or over a test range, such as 10 GHz to 25 GHz.

To form an electrically lossy material, the filler may be conductive particles. Examples of conductive particles that may be used as a filler to form an electrically lossy material include carbon or graphite formed as fibers, flakes, nanoparticles, or other types of particles. Various forms of fiber, in woven or non-woven form, coated or non-coated may be used. Non-woven carbon fiber is one suitable material. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

Preferably, the fillers will be present in a sufficient volume percentage to allow conducting paths to be created from particle to particle. For example, when metal fiber is used, the fiber may be present in about 3% to 30% by volume. The amount of filler may impact the conducting properties of the material, and the volume percentage of filler may be lower in this range to provide sufficient loss.

The binder or matrix may be any material that will set, cure, or can otherwise be used to position the filler material. In some embodiments, the binder may be a thermoplastic material traditionally used in the manufacture of electrical connectors to facilitate the molding of the electrically lossy material into the desired shapes and locations as part of the manufacture of the electrical connector. Examples of such materials include liquid crystal polymer (LCP) and nylon. However, many alternative forms of binder materials may be used. Curable materials, such as epoxies, may serve as a binder. Alternatively, materials such as thermosetting resins or adhesives may be used.

While the above-described binder materials may be used to create an electrically lossy material by forming a binder around conducting particle fillers, lossy materials may be formed with other binders or in other ways. In some examples, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Materials with higher loss tangents may also be used.

In some embodiments, a magnetically lossy material may be formed of a binder or matrix material filled with particles that provide that layer with magnetically lossy characteristics. The magnetically lossy particles may be in any convenient form, such as flakes or fibers. Ferrites are common magnetically lossy materials. Materials such as magnesium ferrite, nickel ferrite, lithium ferrite, yttrium garnet or aluminum garnet may be used. Ferrites will generally have a loss tangent above 0.1 at the frequency range of interest. Presently preferred ferrite materials have a loss tangent between approximately 0.1 and 1.0 over the frequency range of 1 GHz to 3 GHz and more preferably a magnetic loss tangent above 0.5 over that frequency range.

Practical magnetically lossy materials or mixtures containing magnetically lossy materials may also exhibit useful amounts of dielectric loss or conductive loss effects over portions of the frequency range of interest. Suitable materials may be formed by adding fillers that produce magnetic loss to a binder, similar to the way that electrically lossy materials may be formed, as described above.

It is possible that a material may simultaneously be a lossy dielectric or a lossy conductor and a magnetically lossy material. Such materials may be formed, for example, by using magnetically lossy fillers that are partially conductive or by using a combination of magnetically lossy and electrically lossy fillers.

Lossy portions also may be formed in a number of ways. In some examples the binder material, with fillers, may be molded into a desired shape and then set in that shape. In other examples the binder material may be formed into a sheet or other shape, from which a lossy member of a desired shape may be cut. In some embodiments, a lossy portion may be formed by interleaving layers of lossy and conductive material such as metal foil. These layers may be rigidly attached to one another, such as through the use of epoxy or other adhesive, or may be held together in any other suitable way. The layers may be of the desired shape before being secured to one another or may be stamped or otherwise shaped after they are held together. As a further alternative, lossy portions may be formed by plating plastic or other insulative material with a lossy coating, such as a diffuse metal coating.

Although the sizes of the gaps S between the conductive elements 200 and the side surfaces of the insulating spacer 500 can be effectively controlled by the above-described structures, it is difficult to precisely control the gaps S in mass production. Resonance in the ground conductive elements 220 may be effectively suppressed by manufacturing the second member 400 with the lossy material, so that shielding is formed between adjacent signal conductive elements or adjacent pairs of signal conductive elements, thereby preventing signals carried on one signal conductive element 210 from creating crosstalk on the other signal conductive element 210. Therefore, signal interferences may be reduced by suppressing resonance, and thereby signal transmission speed and signal integrity can be effectively improved. Shielding may also have effect on impedance of each conductive element 200, which may further contribute to achieving the desired electrical property.

Exemplarily, the plurality of conductive elements 200 may be arranged in two rows in the longitudinal direction X-X on the two sides of the insulating spacer 500. The two sides of the insulating spacer 500 may be opposite to each other in a predetermined direction. Exemplarily, the predetermined direction may be the transverse direction Y-Y. The second member 400 may extend out of the two sides of the insulating spacer 500 in the transverse direction Y-Y. The second member 400 may be sandwiched between at least a portion of the conductive elements 200 in the two rows of conductive elements 200 in the transverse direction Y-Y.

The second member 400 may include a body 410 and a plurality of projections 420. The body 410 may be accommodated in the insulating spacer 500. The plurality of projections 420 may extend out of the insulating spacer 500 from the two sides of the insulating spacer 500. The plurality of projections 420 may abut the intermediate portions of at least a portion of the plurality of conductive elements 200. Therefore, the spacing between the two rows of conductive elements 200 may be the width of the second member 400. In this way, the spacing between the two rows of conductive elements 200 may be better controlled.

Exemplarily, the insulating spacer 500 may include a receiving space 510 passing therethrough in the predetermined direction. The second member 400 may be arranged in the receiving space 510. The second member 400 may be removable in the predetermined direction. In this way, the second member 400 and the insulating spacer 500 are convenient to mount and dismount.

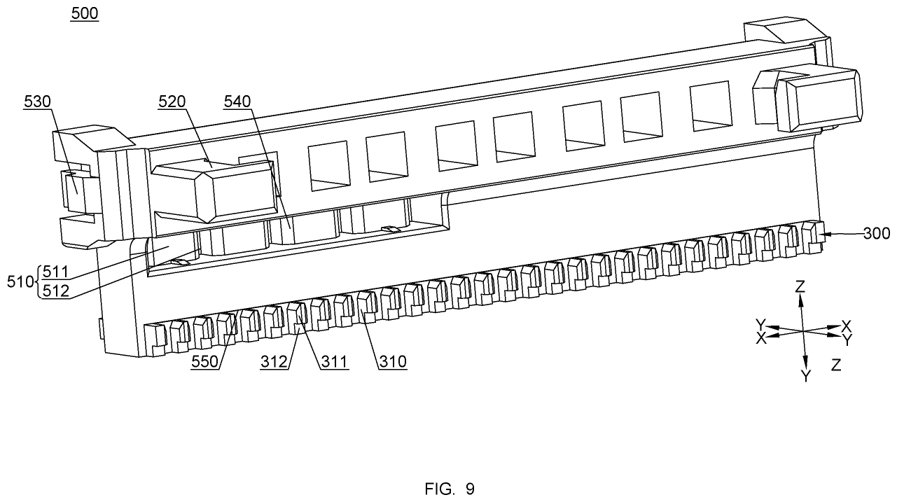

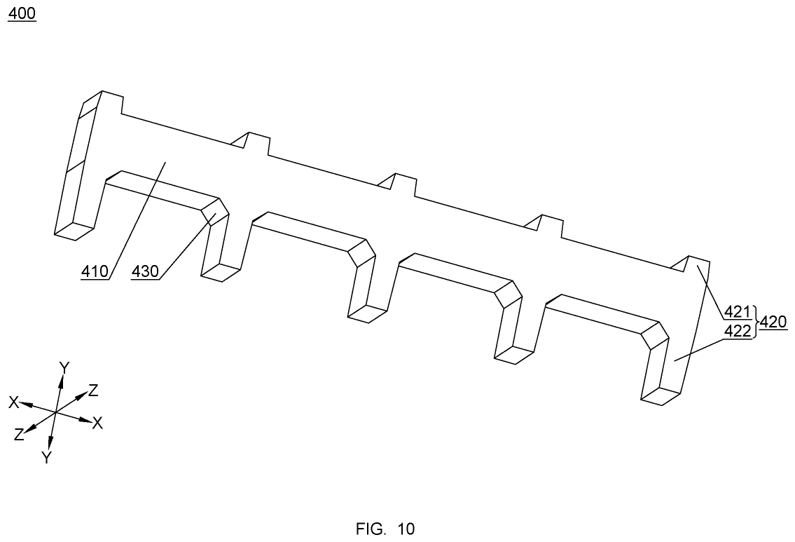

Exemplarily, as shown in FIG. 9 and FIG. 10, the receiving space 510 may further include a recess 511 and a plurality of openings 512. The recess 511 may be recessed from one of the two sides of the insulating spacer 500 in the predetermined direction. The plurality of openings 512 may extend from a bottom of the recess 511 in the predetermined direction to the other of the two sides. The plurality of projections 420 may include a plurality of first projections 421 and a plurality of second projections 422. The plurality of first projections 421 may protrude from the insulating spacer 500 via an opening of the recess 511. The plurality of second projections 422 may protrude from the insulating spacer 500 via the plurality of openings 512 in one-to-one correspondence. The second member 400 may be removable in the predetermined direction so as to be inserted into or removed from the opening of the recess 511. During installation of the second member 400 into the receiving space 510, the bottom of the recess 511 may play a role of limiting, so that the second member 400 may be placed at a desired position in the predetermined direction. The second member 400 may be further limited at a desired position by the plurality of openings 512 in the longitudinal direction X-X. Therefore, the second member 400 can be well positioned by the receiving space 510.

Exemplarily, in the predetermined direction, a length B of the plurality of second projections 422 may be greater than a length A of openings 512, and a total length D of the second member 400 may be greater than a length C of the receiving space 510. In this way, when the second member 400 is mounted in place, the second member 400 may extend out of the insulating spacer 500 from two sides of the receiving space 510 in the predetermined direction. The spacing between the row of conductive elements 200 abutting the second projections 422 and the insulating spacer 500 may be B-A. The sum of the spacings between the two rows of conductive elements 200 respectively and the insulating spacer 500 may be D-C. The spacing B-A between each row of conductive elements 200 and the insulating spacer 500 may be (D-C)/2.

Exemplarily, the length of the plurality of second projections 422 may be greater than that of the plurality of first projections 421. In this way, the spacing between the bottom of the recess 511 and the side surface of the insulating spacer 500 from which the second projections 422 protrude, i.e. the length A of openings 512, can be relatively larger, which may enable the receiving space 510 to have sufficient mechanical strength.

Exemplarily, the length of the plurality of second projections 422 may be greater than that of the plurality of openings 512. In this way, when the second member 400 abut the bottom of the recess 511, the plurality of second projections 422 may protrude from the insulating spacer 500 via the plurality of openings 512 in one-to-one correspondence.

Exemplarily, the plurality of first projections 421 may have a lesser longitudinal dimension in a direction from projection roots to projection tips. With such arrangement, the projection roots may ensure that the plurality of first projections 421 have relatively higher mechanical strength. The projection tips may prevent the plurality of first projections 421 from contacting undesirable conductive elements 200.

Exemplarily, the plurality of second projections 422 have a greater longitudinal dimension in a direction from projection roots to projection tips. With such arrangement, the projection roots may ensure that the plurality of second projections 422 have relatively higher mechanical strength. The projection tips may prevent the plurality of second projections 422 from contacting undesirable conductive elements 200. And such second projections 422 may further be guided when inserted into the plurality of openings 512 correspondingly.

Exemplarily, an end of each of the plurality of openings 512 facing the recess 511 may include edge 540. The edge 540 may play a role of guiding, which is convenient for the plurality of second projections 422 to be inserted into the plurality of openings 512 correspondingly.

Exemplarily, a corner portion 430 may be arranged at the connection of each of the plurality of second projections 422 to the body 410. The corner portions 430 may improve the mechanical strength of the plurality of second projections 422 such that the plurality of second projections 422 are less likely to break even if their length is relatively longer.

In some embodiments, a plurality of heat staking portions 310 may be arranged on the insulating spacer 500. The plurality of heat staking portions 310 may protrude from the insulating spacer 500. In an embodiment where two sides of the insulating spacer 500 may be oppositely arranged in the transverse direction Y-Y, the heat staking portions 310 may respectively protrude outward from two sides of the insulating spacer 500 opposite to each other in the transverse direction Y-Y. The plurality of heat staking portions 310 may be spaced apart in the longitudinal direction X-X.

The plurality of heat staking portions 310 may be used as the first members 300. The plurality of heat staking portions 310 are fixed by heat staking with the ends of the plurality of conductive elements 200. The heat staking portions 310 may be made of a thermoplastic material such as polypropylene (PP), acrylonitrile-butadiene-styrene (ABS), or polycarbonate (PC). Thermoplastic materials are known to those skilled in the art and details are not described herein for the sake of brevity.

After the conductive elements 200 are mounted at desired positions, the heat staking portions 310 may be heated by a high frequency soldering machine or other suitable apparatus until the heat staking portions 310 are melted to wrap the ends of the conductive elements 200. After the heat staking portions 310 are cooled, the heat staking portions 310 may be fixed with the ends of the plurality of conductive elements 200. With such arrangement, the ends of the conductive elements 200 may be firmly fixed by the heat staking portions 310 to maintain the positions of the conductive elements 200, so that the gaps may be controlled to meet the expected requirements and the integrity of the transmitted signal may be improved. Moreover, the production process has many advantages such as high efficiency, energy saving, low production costs, and high product quality.

Exemplarily, in the longitudinal direction X-X, any two adjacent heat staking portions 310 may have one conductive element 200 therebetween. With such arrangement, the ends of the conductive elements 200 can be uniformly wrapped by the heat staking portions 310 after heat staking, thereby preventing the individual conductive element 200 from being loosened by the heat staking portions 310. Moreover, the ends of the plurality of conductive elements 200 may be restricted by the plurality of heat staking portions 310 before heat staking. The conductive elements 200 can be held in gaps between adjacent heat staking portions 310 correspondingly, so that the conductive elements 200 may be pre-positioned.

Exemplarily, the plurality of heat staking portions 310 may protrude from the plurality of conductive elements 200 before heat staking. The protruding ends of the plurality of heat staking portions 310 may have edges 311. The conductive elements 200 may be guided by the edges 311 when inserted into the gaps between adjacent heat staking portions 310.

Exemplarily, a cut 312 may be arranged on an end of each of the plurality of heat staking portions 310 close to the mounting surface 120. The cut 312 may leave more space at the mounting surface 120, thereby facilitating the soldering of the conductive elements 200 to a printed circuit board.

The present disclosure has been described through the above embodiments, but it should be understood that a variety of variations, modifications and improvements may be made by a person skilled in the art according to the teaching of the present disclosure, and these variations, modifications and improvements all fall within the spirit of the present disclosure and the claimed scope of protection of the present disclosure. The scope of protection of the present disclosure is defined by the appended claims and its equivalent scope. The above embodiments are only for the purpose of illustration and description, and are not intended to limit the present disclosure to the scope of the described embodiments.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like usually are shown based on the accompanying drawings, only for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

Various variations may be made to the structures illustrated and described herein. For example, the positioning assembly described above can be used in any suitable electrical connector, such as backplane connectors, daughter card connectors, stacking connectors, Mezzanine connectors, I/O connectors, chip sockets, Gen Z connectors, etc.

Moreover, although many creative aspects have been described above with reference to the right angle connectors, it should be understood that the aspects of the present disclosure are not limited to these. Any one of the creative features, whether alone or combined with one or more other creative features, can also be used for other types of card edge connectors, such as vertical connectors and coplanar connectors, and the like.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1. An electrical connector, comprising:
a housing having an interfacing surface, a mounting surface, and a slot at the interfacing surface, wherein the housing is elongated in a longitudinal direction;
a plurality of conductive elements held by the housing and disposed in first and second rows parallel to the longitudinal direction, each of the plurality of conductive elements comprising a contact end having a contact portion curving into the slot, a mounting end extending out of the mounting surface, and an intermediate portion comprising a first portion and a second portion;
a spacer disposed between the first and second rows, the spacer comprising a first portion disposed between the first portions of the conductive elements, a second portion disposed between the second portions of the conductive elements, and a plurality of first members extending from the first portion of the spacer and contacting the plurality of conductive elements at first locations of the plurality of conductive elements; and
a second member disposed between the first and second portions of the spacer and contacting at least a portion of the plurality of conductive elements at second locations of the plurality of conductive elements.

2. The electrical connector of claim 1, comprising:
a first gap between the first row of the conductive elements and the first portion of the spacer, wherein:
the first gap has a width in a transverse direction perpendicular to the longitudinal direction; and
the width of the first gap is uniform in a vertical direction perpendicular to both the transverse direction and the longitudinal direction.

3. The electrical connector of claim 2, comprising:
a second gap between the second row of the conductive elements and the first portion of the spacer, wherein:
the second gap has a width in the transverse direction; and
the width of the second gap is uniform in the vertical direction.

4. The electrical connector of claim 3, comprising:
a third gap between the first row of the conductive elements and the second portion of the spacer, wherein:
the third gap has a width in the transverse direction; and
the width of the third gap is uniform in the vertical direction.

5. The electrical connector of claim 4, comprising:
a fourth gap between the first row of the conductive elements and the second portion of the spacer,
wherein:
the interfacing surface and mounting surface are perpendicular to each other;
the fourth gap has a width in the vertical direction; and
the width of the fourth gap is uniform in the transverse direction.

6. The electrical connector of claim 5, comprising:
a fifth gap between the second row of the conductive elements and the second portion of the spacer, wherein:
the fifth gap has a width in the vertical direction; and
the width of the fifth gap is uniform in the transverse direction.

7. The electrical connector of claim 1, wherein:
the spacer is insulative;
the second member is lossy; and
the at least a portion of the plurality of conductive elements are configured for grounding.

8. The electrical connector of claim 1, comprising:
a third member contacting the plurality of conductive elements at third locations of the plurality of conductive elements, wherein:
the third locations are between the contact ends and the second locations of the plurality of conductive elements.

9. The electrical connector of claim 1, wherein:
the third member comprises notches on opposite ends in the longitudinal direction; and
the second portion of the spacer comprises latches disposed in the notches of the third member.

10. The electrical connector of claim 1, wherein:
the spacer comprises a receiving space between the first and second portions; and
the second member is removably disposed in the receiving space of the spacer.

11. The electrical connector of claim 10, wherein:
the receiving space comprises a recess and a plurality of openings;
the recess is disposed at a first side of the spacer; and
the plurality of openings extend from the recess to a second side of the spacer, the second side being opposite the first side.

12. The electrical connector of claim 11, wherein the second member comprises:
a body disposed in the recess of the spacer,
a plurality of first projections protruding towards the second row of conductive elements, and
a plurality of second projections disposed in respective ones of the plurality of openings of the spacer and protruding towards the first row of conductive elements.

13. The electrical connector of claim 12, wherein:
the plurality of second projections extend longer than the plurality of first projections.

14. An electrical connector, comprising:
a housing having an interfacing surface, a mounting surface, and a slot at the interfacing surface and elongating in a longitudinal direction;
a plurality of conductive elements held by the housing and disposed in first and second rows parallel to the longitudinal direction, each of the plurality of conductive elements comprising a contact end having a contact portion curving into the slot, a mounting end extending out of the mounting surface, and an intermediate portion comprising a first portion and a second portion; and
a spacer disposed between the first and second rows, the spacer comprising a plurality of first members each at least partially wrapping a respective one of the plurality of conductive elements at first locations.

15. The electrical connector of claim 14, wherein:
the first locations are at the mounting ends of the plurality of conductive elements.

16. The electrical connector of claim 14, wherein:
the spacer comprises protrusions disposed on opposite ends in the longitudinal direction; and
the housing comprises matching receivers for the protrusions of the spacer so as to prevent the spacer from moving relative to the housing in the longitudinal direction.

17. The electrical connector of claim 14, wherein:
the spacer comprises a receiving space; and
the electrical connector comprises a second member removably disposed in the receiving space of the spacer and contacting at least a portion of the plurality of conductive elements at second locations.

18. An electrical connector, comprising:
a housing having an interfacing surface, a mounting surface, and a slot at the interfacing surface and elongating in a longitudinal direction;
a plurality of conductive elements held by the housing and disposed in first and second rows parallel to the longitudinal direction, each of the plurality of conductive elements comprising a contact end having a contact portion curving into the slot, a mounting end extending out of the mounting surface, and an intermediate portion comprising a first portion and a second portion;
a spacer disposed between the first and second rows; and
a lossy member disposed in the spacer and comprising a plurality of projections extending beyond the spacer to make contact with at least a portion of the plurality of conductive elements.

19. The electrical connector of claim 18, wherein:
the spacer is separated from the first and second rows of conductive elements by first and second gaps, respectively; and
sizes of the gaps are at least partially determined by a difference between lengths of the lossy member and the spacer in a transverse direction perpendicular to the longitudinal direction.

20. The electrical connector of claim 18, wherein:
the spacer comprises a plurality of insulative members each at least partially wrapping a respective one of the plurality of conductive elements at the mounting ends.
